(19) United States
(12) Patent Application Publication
(10) Pub. No.: US 2017/0266905 A1
(43) Pub. Date: Sep. 21, 2017

(54) Plastic Bag Making Apparatus

(71) Applicant: Totani Corporation, Kyoto (JP)

(72) Inventor: Mikio TOTANI, Kyoto (JP)

(21) Appl. No.: 15/597,327

(22) Filed: May 17, 2017

Related U.S. Application Data
(62) Division of application No. 12/988,879, filed on Nov. 3, 2010.

(30) Foreign Application Priority Data
Apr. 24, 2008 (JP) 2008-114658

(51) Int. Cl. B31B 19/26

(52) U.S. Cl. CPC B31B 19/00; B31B 2237/20; B31B 2237/50; B31B 2237/406

(57) ABSTRACT

In order to provide an apparatus for successively making plastic bags each of which includes panel portions and a bottom gusset portion, in a way different from the prior art, upper and lower webs of panel material are superposed on each other and fed longitudinally thereof. A web of bottom gusset material is supplied to one of the webs of panel material to be superposed on the outer surface thereof, the web of bottom gusset material having opposite side edges one of which extends along ones of the opposite side edges of the webs of panel material. The web of bottom gusset material and the other web of panel material are temporarily fixed to each other at ones of the opposite side edges thereof after the webs of panel material are superposed and the web of bottom gusset material is supplied. One of the webs or the other web of panel material and the web of bottom gusset material are then guided so that one of the webs or the other web of panel material can be folded at a position adjacent to ones of the opposite side edges of the webs of panel material when the webs of panel material are fed. The web of bottom gusset material is combined with the webs of panel material. The panel portions are formed by the webs of panel material while the bottom gusset portion is formed by the web of bottom gusset material.

### TECHNICAL FIELD

The invention relates to an apparatus for successively making plastic bags.

### BACKGROUND

There has been used a plastic bag including panel portions and a bottom gusset portion. The plastic bag is called a rectangular bottom bag. In addition, there has been proposed an apparatus for successively making the rectangular bottom bags, as disclosed in Japanese Patent Publication No. 3,655,627.

The apparatus includes panel material feeding means by which upper and lower webs of panel material are superposed on each other and fed longitudinally thereof. The apparatus further includes guide means by which the upper web of panel material is guided to be folded when the webs of panel material are fed. In addition, the lower web of panel material is guided by the guide means to be folded and then folded back so that a folded portion can be formed in the lower web of panel material and folded into halves. The upper web of panel material is guided by the guide means to be unfolded. The panel portions are formed by the webs of panel material while the bottom gusset portion is formed by the folded portion.

However, in the apparatus, the guide means has not only to make the upper web of panel material folded and then unfolded but also to make the lower web of panel material folded and then folded back, to be complicated in structure. It is therefore desired to successively make the rectangular bottom bags in a way different from the apparatus.

It is therefore an object of the invention to provide an apparatus for successively making plastic bags each of which includes panel portions and a bottom gusset portion, in a way different from the prior art.

Another object is to provide the apparatus which has only to make one of the webs of panel material folded and then unfolded and has not to make the other web of panel material folded and then folded back.

### SUMMARY OF THE INVENTION

According to the invention, the apparatus includes panel material feeding means by which upper and lower webs of panel material are superposed on each other and fed longitudinally thereof, the webs of panel material having outer surfaces and opposite side edges. The apparatus further includes bottom gusset material supply means by which a web of bottom gusset material is supplied to one of the webs of panel material to be superposed on the outer surface thereof, the web of bottom gusset material having opposite side edges one of which extends along ones of the opposite side edges of the webs of panel material. The apparatus further includes temporarily fixing means by which the web of bottom gusset material and the other web of panel material are temporarily fixed to each other at ones of the opposite side edges thereof after the webs of panel material are superposed and the web of bottom gusset material is supplied. The apparatus further includes guide means by which one of the webs or the other web of panel material and the web of bottom gusset material are guided so that one of the webs or the other web of panel material can be folded at a position adjacent to ones of the opposite side edges of the webs of panel material when the webs of panel material are fed and after the web of bottom gusset material and the other web of panel material are temporarily fixed. The web of bottom gusset material is combined with the webs of panel material. The panel portions are formed by the webs of panel material while the bottom gusset portion is formed by the web of bottom gusset material.

In a preferred embodiment, the apparatus further includes side gusset material supply means by which sheets of side gusset material are supplied to and interposed between the webs of panel material to extend widthwise thereof before the web of bottom gusset material is combined, one of the webs or the other web of panel material being guided by the guide means to be folded after the sheet of side gusset material is interposed. The web of bottom gusset material is combined with the sheet of side gusset material. The plastic bag includes side gusset portions formed by the sheets of side gusset material.

The apparatus further includes longitudinal seal means by which the webs of panel material and the web of bottom gusset material are heat sealed with each other along ones of the opposite side edges of the webs of panel material after the web of bottom gusset material is combined. The apparatus further includes cross seal means by which the webs of panel material and the sheet of side gusset material are heat sealed with each other widthwise of the webs of panel material after the web of bottom gusset material is combined.

One of the webs or the other web of panel material is guided by the guide means to be unfolded after being folded. The web of bottom gusset material is folded and interposed between the webs of panel material. The web of bottom gusset material is combined with the sheet of side gusset material by means of procedures in which one of the webs or the other web of panel material is folded and then unfolded.

One of the webs of panel material comprises the upper web of panel material having an upper surface. The web of bottom gusset material is supplied to the upper web of panel material to be superposed on the upper surface thereof. The web of bottom gusset material and the lower web of panel material are then temporarily fixed to each other at ones of the opposite side edges thereof. The upper web of panel material is guided by the guide means to be folded after the web of bottom gusset material and the lower web of panel material are temporarily fixed.

One of the webs of panel material may comprise the lower web of panel material having a lower surface. In this case, the web of bottom gusset material is supplied to the lower web of panel material to be superposed on the lower surface thereof. The web of bottom gusset material and the upper web of panel material are then temporarily fixed to each other at ones of the opposite side edges thereof. The upper web of panel material is guided by the guide means to be folded after the web of bottom gusset material and the upper web of panel material are temporarily fixed.

The web of bottom gusset material is supplied to one of the webs of panel material after the webs of panel material are superposed on each other.

The web of bottom gusset material may be supplied to one of the webs of panel material before the webs of panel material are superposed on each other.

The apparatus may include dividing means by which one of the webs of panel material is divided widthwise thereof to have a pair of divided edges extending longitudinally of the webs of panel material. The apparatus further includes bottom gusset material supply means by which a web of bottom gusset material is supplied to one of the webs of panel material to be superposed on the outer surface thereof, the web of bottom gusset material including a central portion disposed along the divided side edges of one of the webs of panel material. The apparatus further includes temporarily fixing means by which the web of bottom gusset material and the other web of panel material are temporarily fixed to each other at the central portion of the web of bottom gusset material and between the divided side edges of one of the webs of panel material after the webs of panel material are superposed on each other, one of the webs of panel material is divided and the web of bottom gusset material is supplied. The apparatus further includes guide means by which one of the webs of panel material and the web of bottom gusset material are guided so that one of the webs of panel material can be folded at a position adjacent to the divided side edges thereof when the webs of panel material are fed and after the web of bottom gusset material and the other web of panel material are temporarily fixed. The web of bottom gusset material is combined with the webs of panel material. The panel portions are formed by the webs of panel material while the bottom gusset portion is formed by the web of bottom gusset material.

The sheets of side gusset material may be supplied to and interposed between the webs of panel material to extend widthwise thereof before the web of panel material is combined. The sheets of side gusset material are disposed on opposite sides of the divided side edges widthwise of the webs of panel material.

The webs of panel material and the web of bottom gusset material may be heat sealed with each other along the divided side edges of one of the webs of panel material after the web of bottom gusset material is combined. The webs of panel material and the sheet of side gusset material are heat sealed with each other widthwise of the webs of panel material after the web of bottom gusset material is combined.

The dividing means may comprise a pair of slitting blades spaced from each other widthwise of the webs of panel material. One of the webs of panel material is slit to be divided along longitudinal slit lines by the slitting blades so that the divided side edges can be spaced from and opposed to each other widthwise of the webs of panel material.

The dividing means may comprise a pair of perforating blades spaced from each other widthwise of the webs of panel material. One of the webs of panel material is perforated to be divided along longitudinal perforations by the perforating blades so that the divided side edges can be spaced from and opposed to each other widthwise of the webs of panel material.

An elongated portion may be formed between the divided side edges and then separated from one of the webs of panel material so that the web of bottom gusset material and the other web of panel material can be temporarily fixed to each other directly.

The apparatus may further comprise temporarily fixing means by which the web of bottom gusset material and one of the webs of panel material are temporarily fixed to each other at the central portion of the web of bottom gusset material after the web of bottom gusset material is supplied. An elongated portion is formed between the divided side edges and then separated from one of the webs of panel material so that the web of bottom gusset material and the other web of panel material can be temporarily fixed to each other indirectly by the elongated portion which is temporarily fixed to the other web of panel material directly.

### BRIEF DESCRIPTION OF THE DRAWINGS

FIG. 1 is a perspective view of a preferred embodiment of the invention.

FIG. 2 is an enlarged view of the webs of panel material and the web of bottom gusset material of the apparatus of FIG. 1.

FIG. 3 is an enlarged view of the webs of panel material and the web of bottom gusset material of the apparatus of FIG. 2 viewed in a different direction.

FIG. 4 is an enlarged view of the guide means of the apparatus of FIG. 3.

FIGS. 5A, 5B, 5C and 5D are sectional views of the webs of panel material and the web of bottom gusset material when being folded.

FIG. 6 is an explanatory view of the webs of panel material and web of bottom gusset material when being supplied.

FIG. 7 is an explanatory view of another embodiment.

FIG. 8 is an explanatory view of the cross and longitudinal seal means of FIG. 1.

FIG. 9 is an elevational view of a plastic bag obtained by the apparatus of FIG. 1.

FIG. 10 is an explosive view of the plastic bag of FIG. 9.

FIG. 11 is an explanatory view of the side gusset portion of FIG. 10.

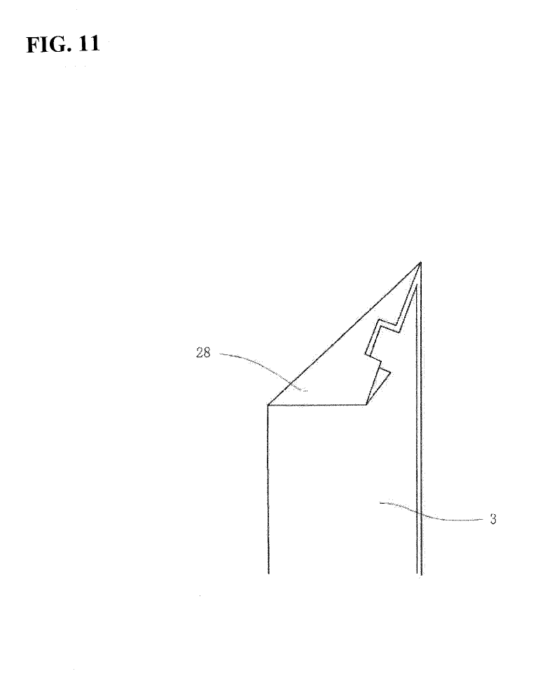

FIG. 12 is a perspective view of another embodiment.

FIGS. 13A and 13B are sectional views of another embodiment when being folded.

FIGS. 14A, 14B, 14C and 14D are sectional views of an example of reference when being folded.

FIGS. 15A, 15B, and 15C are sectional views of another embodiment when being folded.

FIGS. 16A, 16B, 16C and 16D are sectional views of the prior art when being folded.

FIG. 17 is a plan view of another embodiment.

FIG. 18A is a plan view and FIG. 18B is a side view of another embodiment.

FIG. 19 is a plan view of another embodiment.

FIG. 20 is a plan view of another embodiment.

FIG. 21 is a plan view of another embodiment.

FIG. 22A is an elevational view and FIG. 22B is a side view of another embodiment.

FIG. 23 is an explanatory view of another embodiment.

### BEST MODE TO CARRY OUT THE INVENTION

Embodiments of the invention are as follows.

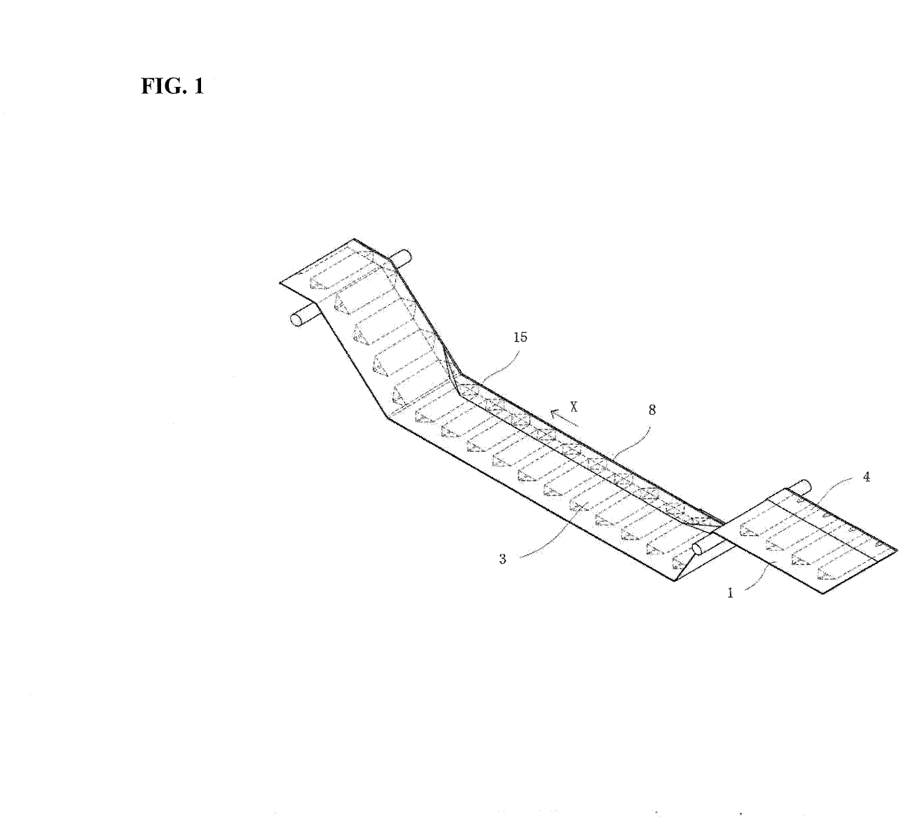

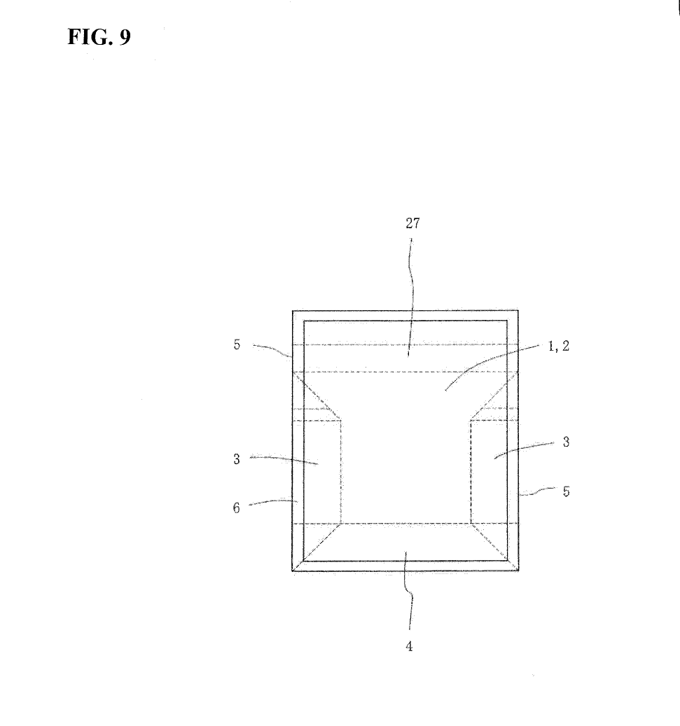

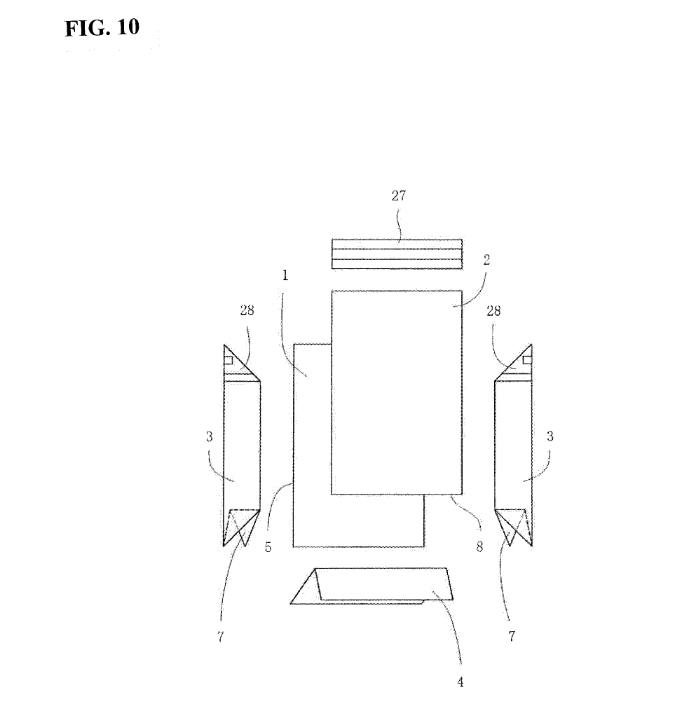

Turning now to the drawings, FIG. 1 illustrates an apparatus for successively making plastic bags, according to the invention. Each of the plastic bags includes panel portions 1 and 2, side gusset portions 3 and a bottom gusset portion 4, as shown in FIG. 9 and as in the case of the plastic bag of Japanese Patent Publication No. 3,655,627. The panel portions 1 and 2 are superposed on each other into two layers to have opposite side edges 5 along which the side gusset portions 3 extend, as shown in FIG. 10. The side gusset portions 3 are folded into halves and interposed between the panel portions 1 and 2. The panel portions 1 and 2 and the side gusset portions 3 are heat sealed with each other along the side edges 5 of the panel material 1 and 2 so that heat seal lines 6 can be formed along the side edges 5. In addition, each of the side gusset portions 3 has opposite ends portions one of which is folded at an angle of 45°. The end portion is folded into halves and interposed between the layers of the side gusset portion 3 so that an auxiliary gusset portion 7 can be formed by the end portion.

The panel portions 1 and 2 have bottom edges 8 along which the bottom gusset portion 4 extend, as also in the case of the plastic bag of the publication. The bottom gusset portion 4 is folded into halves and interposed between the panel portions 1 and 2. In addition, the auxiliary gusset portions 7 and the bottom gusset portion 4 are heat sealed with each other along the side edges 5 of the panel portion 1 and 2 so that heat seal lines 6 can be formed along the side edges 5. The panel portions 1 and 2 and the bottom gusset portion 4 are heat sealed with each other along the bottom edges 8 of the panel portions 1 and 2 so that heat sealed lines 6 can be formed along the bottom edges 8. The plastic bag can therefore be enlarged by the side gusset portions 3 to obtain an increased capacity. A flat bottom surface can be formed by the bottom gusset portion 4 to make the plastic bag stand stably.

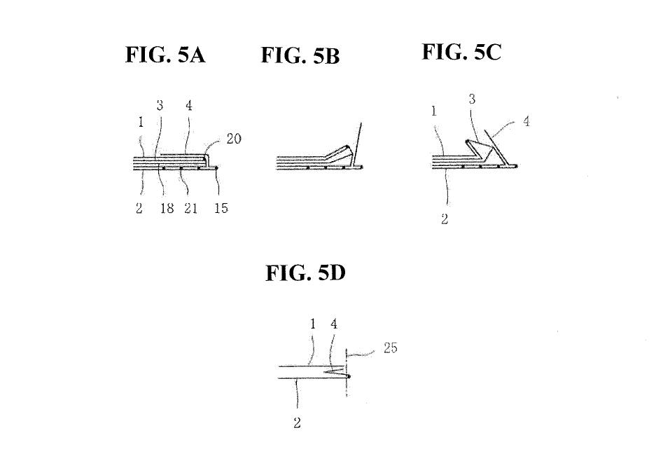

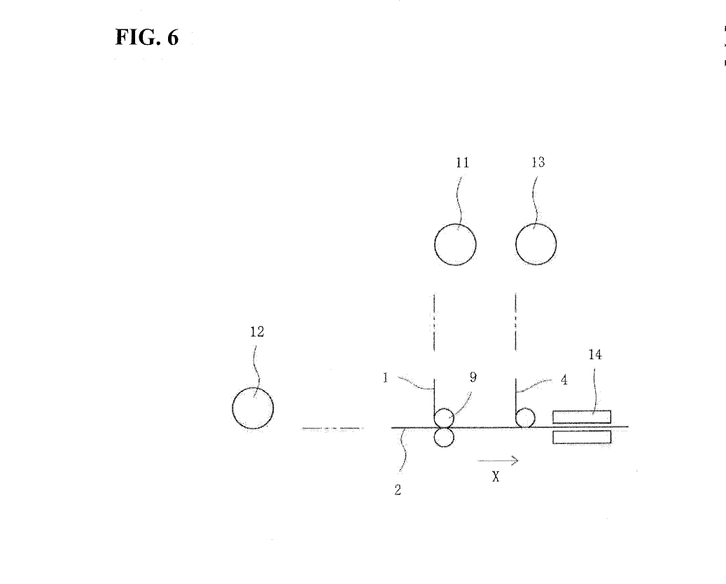

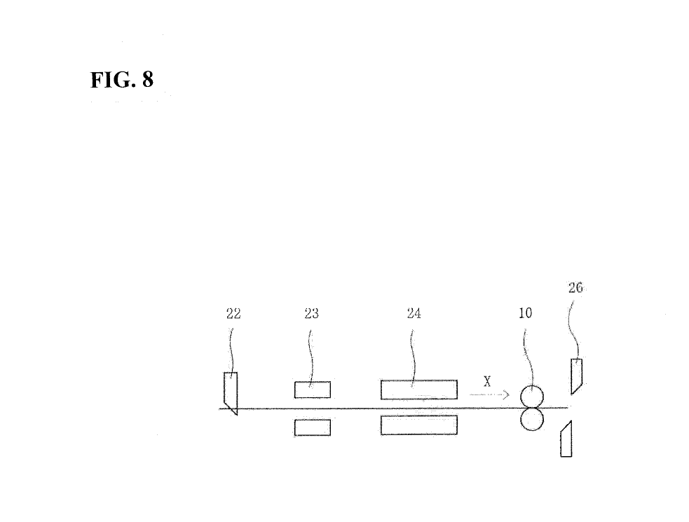

In order to successively make the plastic bags of FIG. 9, the apparatus includes panel material feeding means by which upper and lower webs of panel material 1 and 2 are superposed on each other and fed longitudinally thereof, as shown in FIG. 5. The webs of panel material 1 and 2 comprise plastic films by which the panel portions 1 and 2 of FIG. 10 are formed. In the embodiment, the panel material feeding means comprises feeding rollers 9 and 10, as shown in FIGS. 6 and 8, the upper web of panel material 1 being directed to the feeding rollers 9 from a roll 11. The lower web of panel material 2 is directed to the feeding rollers 9 from a roll 12. The upper and lower webs of panel material 1 and 2 are superposed on each other when being directed to the feeding rollers 9. The upper and lower webs of panel material 1 and 2 are then directed to the feeding rollers 10. The feeding rollers 9 and 10 are rotated by a drive motor so that the webs of panel material 1 and 2 can be fed longitudinally thereof. The webs of panel material 1 and 2 are fed in a direction X and intermittently.

The apparatus further includes side gusset material supply means by which sheets of side gusset material 3 are supplied to and interposed between the webs of panel material 1 and 2 to extend widthwise thereof. For example, each of the sheets of side gusset material 3 is previously folded into halves. The sheet of side gusset material 3 is then supplied to the lower web of panel material 1 and put on the upper surface thereof to extend widthwise of the lower web of panel material 1 before the webs of panel material 1 and 2 are superposed on each other and whenever the webs of panel material 1 and 2 are fed intermittently. The sheets of side gusset material 3 comprise plastic films by which the side gusset portions 3 of FIG. 10 are formed. In the embodiment, the sheet of side gusset material 3 has a double width, which is previously folded into halves on the opposite sides of the longitudinal centerline to be superposed into two layers, as in the case of the plastic bag of Japanese Patent Publication No. 3,655,627. In addition, the sheet of side gusset material 3 has opposite end portions one of which is folded at an angle of 45°. The end portion is folded into halves and interposed between the layers of the sheet of side gusset material 3 to make the auxiliary gusset portion 7 of FIG. 10 formed by the end portion. The sheet of side gusset material 3 is then supplied to the lower web of panel material 2 and put on the upper surface thereof to extend widthwise of the lower web of panel material 2 whenever the webs of panel material 1 and 2 are fed intermittently. The sheet of side gusset material 3 is therefore interposed between the webs of panel material 1 and 2 when the webs of panel material 1 and 2 are superposed on each other. It should be noted that the side gusset material supply means has the same structure as that of Japanese Laid-Open Patent Publication No. 254,984 of 2000. No reference is therefore made to the structure herein.

In addition, it should be understood that the webs of panel material 1 and 2 have outer surfaces and opposite side edges 8. The apparatus further includes bottom gusset material supply means by which a web of bottom gusset material 4 is supplied to one of the webs of panel material to be superposed on the outer surface thereof. The web of bottom gusset material 4 has opposite side edges one of which extends along ones of the opposite side edges 8 of the webs of panel material 1 and 2. It should also be understood that the bottom edges 8 of FIG. 10 are formed by ones of the opposite side edges 8. The apparatus further includes temporarily fixing means by which the web of bottom gusset material 4 and the other web of panel material are temporarily fixed to each other at ones of the opposite side edges 8 thereof after the webs of panel material 1 and 2 are superposed and the web of bottom gusset material 4 is supplied.

In the embodiment, one of the webs of panel material comprises the upper web of panel material 1 including an upper surface. The web of bottom gusset material 4 is therefore supplied to the upper web of panel material 1 from a roll 13 to be superposed on the upper surface of the upper web of panel material 1 after the webs of panel material 1 and 2 are superposed on each other. The web of bottom gusset material 4 and the lower web of panel material 2 are then temporarily fixed to each other at ones of the opposite side edges 8 thereof. For example, the temporarily fixing means comprises an ultrasonic seal apparatus 14 by which the web of bottom gusset material 4 and the lower web of panel material 2 are ultrasonic sealed with and temporarily fixed to each other whenever the webs of panel material 1 and 2 are fed intermittently. A temporarily fixed line 15 is therefore formed along ones of the opposite side edges 8 of the webs of panel material 1 and 2.

The apparatus further includes guide means by which one of the webs or the other web of panel material and the web of bottom gusset material 4 are guided so that one of the webs or the other web of panel material can be folded at a position adjacent to ones of the opposite side edges 8 when the webs of panel material 1 and 2 are fed and after the web of bottom gusset material 4 and the other web of panel material are temporarily fixed. The web of bottom gusset material 4 is combined with the webs of panel material 1 and 2. In addition, one of the webs or the other web of panel material is guided by the guide means to be unfolded after being folded. The web of bottom gusset material 4 is folded and interposed between the webs of panel material 1 and 2.

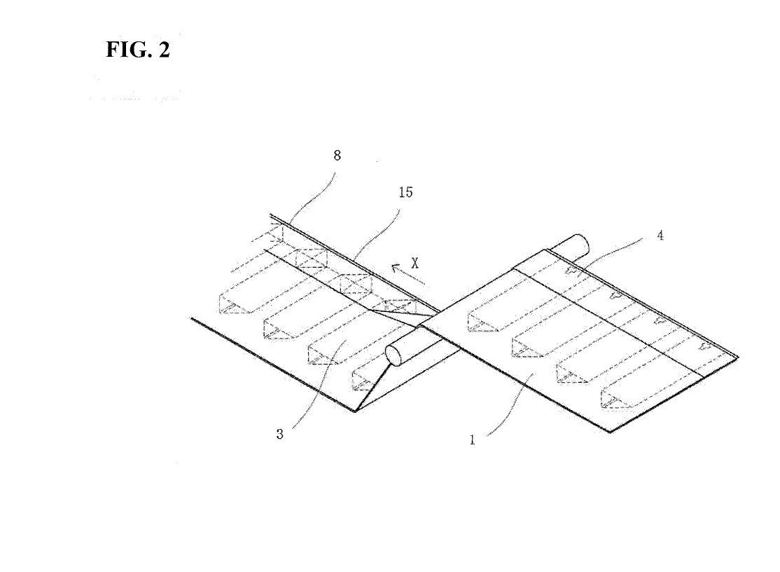

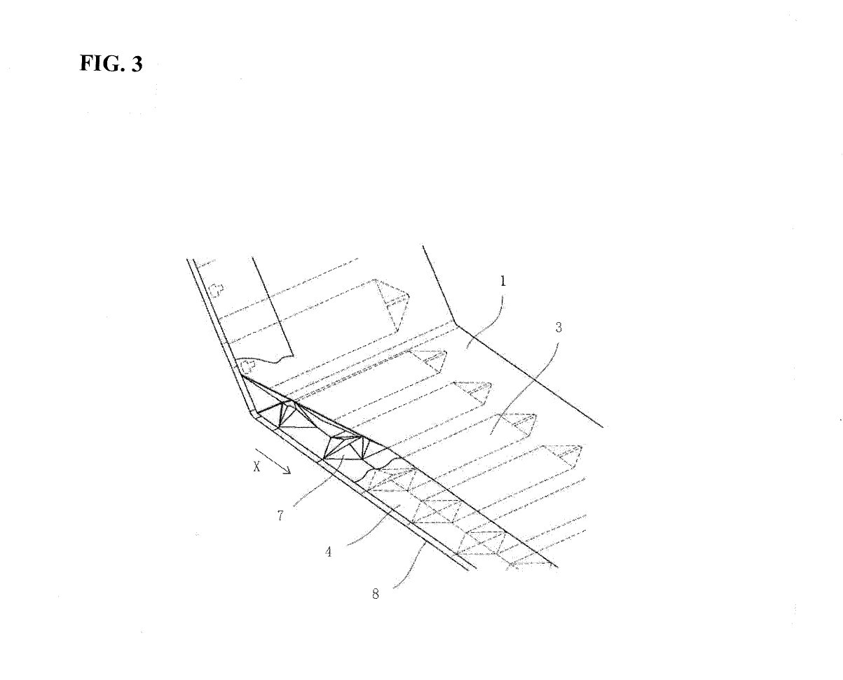

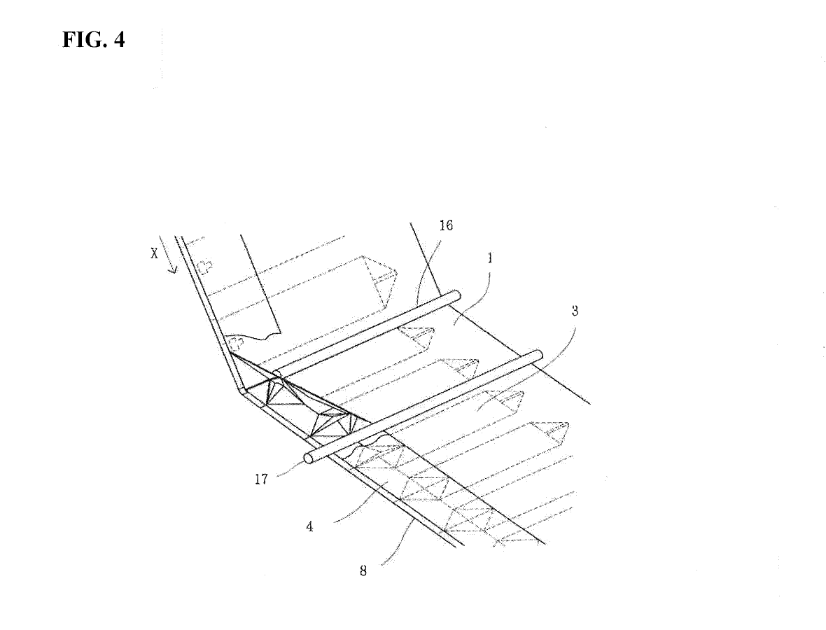

In the embodiment, the guide means includes guide rods 16 and 17, as shown in FIGS. 2, 3 and 4 and as in the case of the guide means of Japanese Patent Publication No. 3,455,627. The webs of panel material 1 and 2 pass through the guide rod 16 to be directed to the guide rod 17 so that the upper web of panel material 1 can be guided by the guide rods 16 and 17 to be raised and folded at a position adjacent to the side edges 8 of the webs of panel material 1 and 2. The upper web of panel material 1 is folded completely when reaching the guide rod 17.

By the way, the sheet of side gusset material 3 includes folded lines 18 formed therein. In addition, the apparatus includes temporarily fixing means comprising an ultrasonic seal apparatus by which the upper web of panel material 1 and the upper layer of the sheet of side gusset material 3 are ultrasonic sealed with and temporarily fixed to each other at one of the opposite end portions of the sheet of side gusset material 3 to make a temporarily fixed portion 20 formed at the end portion. The temporarily fixed portion 20 is formed at the center portion of the sheet of side gusset material 3 widthwise thereof. The lower web of panel material 2 and the lower layer of the sheet of side gusset material 3 are ultrasonic sealed with and temporarily fixed to each other by the ultrasonic seal apparatus at the end portion of the sheet of side gusset material 3 to make temporarily fixed portions 21 formed at the end portion. The temporarily fixed portions 21 are formed along the longitudinal centerline of the sheet of side gusset material 3.

It should be understood that the upper web of panel material 1 is then guided to be raised and folded by the guide rods 16 and 17. The web of bottom gusset material 4 is therefore held by the lower web of panel material 2 and pushed and raised by the upper web of panel material 1 when the upper web of panel material 1 is raised and folded. In addition, the upper layers of the sheet of side gusset material 3 and the auxiliary gusset portion 7 are pulled, raised and folded by the upper web of panel material 1. The lower layers of the sheet of side gusset material 3 and the auxiliary gusset portion 7 are held by the lower web of panel material 2. The sheet of side gusset material 3 and the auxiliary gusset portion 7 are therefore opened by the upper and lower layers thereof and covered with the web of bottom gusset material 4. The sheet of side gusset material 3 and the auxiliary gusset portion 7 are opened completely when the upper web of panel material 1 is folded completely so that an open surface is formed by the sheet of side gusset material 3 and the auxiliary gusset portion 7. The web of bottom gusset material 4 is superposed with the open surface of the sheet of side gusset material 3 and the auxiliary gusset portion 7 so that the open surface can be covered with the web of bottom gusset material 4.

The guide means further includes another rod or plate and the like to which the upper and lower webs of panel material 1 and 2 are directed after the upper web of panel material 1 is folded. The upper web of panel material 1 is guided by another rod or plate and the like to be unfolded. The web of bottom gusset material 4 is guided by another rod or plate and the like to be folded and interposed between the webs of panel material 1 and 2, as shown in FIG. 1.

It should therefore be understood that in the apparatus, the upper web of panel material 1 and the web of bottom gusset material 4 are guided by the guide means so that the upper web of panel material 1 can be folded, the web of bottom gusset material 4 being combined with the webs of panel material 1 and 2 and combined with the sheet of side gusset material 3. The upper web of panel material 1 is then guided by the guide means to be unfolded, the web of bottom gusset material 4 being folded and interposed between the webs of panel material 1 and 2. In addition, the web of bottom gusset material 4 is combined with the sheet of side gusset material 3 by means of procedures in which the upper web of panel material 1 is folded and unfolded.

The upper and lower webs of panel material 1 and 2 are then directed to a slitting blade 22, a cross seal means 23, a longitudinal seal means 24 and the feed roller 10 to be slit by the slitting blade 22, as shown in FIG. 8. The webs of panel material 1 and 2 are slit along a slit line 25, as shown in FIG. 5. In addition, the webs of panel material 1 and 2 and the sheet of side gusset material 3 are heat sealed with each other widthwise of the webs of panel material 1 and 2 by the cross seal means 23 whenever the webs of panel material 1 and 2 are fed intermittently. The auxiliary gusset portion 7 and the web of bottom gusset material 4 are also heat sealed with each other widthwise of the webs of panel material 1 and 2 by the cross seal means 23, to make the heat seal lines 6 of FIG. 9 formed. Furthermore, the webs of panel material 1 and 2 and the web of bottom gusset material 4 are heat sealed with each other along one of the opposite side edges 8 thereof by the longitudinal seal means 24 whenever the webs of panel material 1 and 2 are fed intermittently. The webs of panel material 1 and 2 are then cut widthwise thereof by a cutter 26 whenever being fed intermittently and at a position corresponding to the sheet of side gusset material 3. In the embodiment, the webs of panel material 1 and 2 and the sheet of side gusset material 3 are cut along the longitudinal centerline of the sheet of side gusset material 3, to make the opposite side edges 5 of FIG. 9 formed.

By the way, each of the webs of panel material 1 and 2 and the sheet of side gusset material 3 comprises a laminated film composed of a sealant laminated on a base material. The webs of panel material 1 and 2 have inner surfaces formed by the sealant such as polyethylene or polypropylene and outer surfaces formed by the base material such as nylon. The sheet of side gusset material 3 has outer surfaces formed by the sealant such as polyethylene or polypropylene and inner surfaces formed by the base material such as nylon when being folded into halves. The same is true of the web of bottom gusset material 4. The webs of panel material 1 and 2, the sheet of side gusset material 3 and the web of bottom gusset material 4 can therefore be heat sealed by the cross seal means 23 and the longitudinal seal means 24.

The apparatus can therefore successively make the plastic bags of FIG. 9. The plastic bag may include a zipper 27 incorporated therein, as in the case of that of Japanese Patent Publication No. 3,655,627. The sheet of side gusset material 3 may be folded at one of the opposite end portions thereof so that a triangular flap 28 can be formed at the end portion.

Accordingly, in order to successively make the plastic bags including the side gusset portions 3 and the bottom gusset portion 4 in the apparatus, the guide means has only to make the upper web of panel material 1 folded and then unfolded and has not to make the lower web of panel material 2 folded and then folded back. The apparatus can successively make the plastic bags without making the lower web of panel material 2 folded and then folded back so that the guide means can be simple in structure.

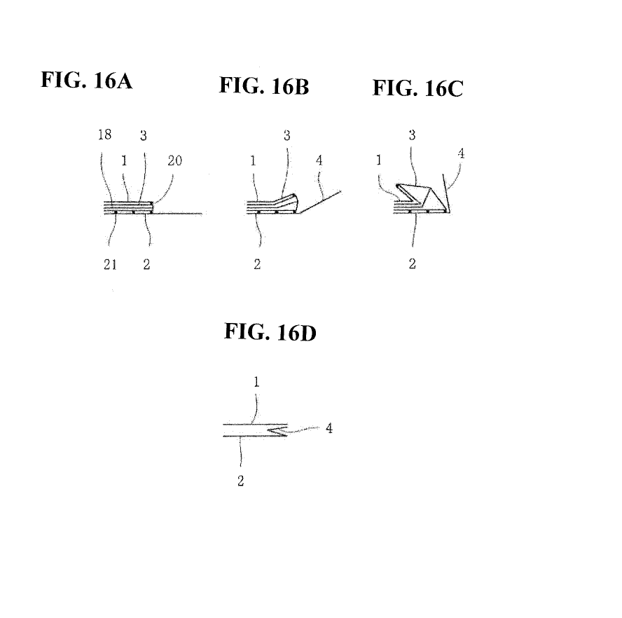

In the apparatus of Japanese Patent publication No. 3,655,627, the guide means has not only to make the upper web of panel material 1 folded and then unfolded but to make the lower web of panel material 2 folded and then folded back so that the bottom portion 4 can be formed by the folded portion of the lower web of panel material 2, to be complicated in structure, as shown in FIG. 16 and described previously.

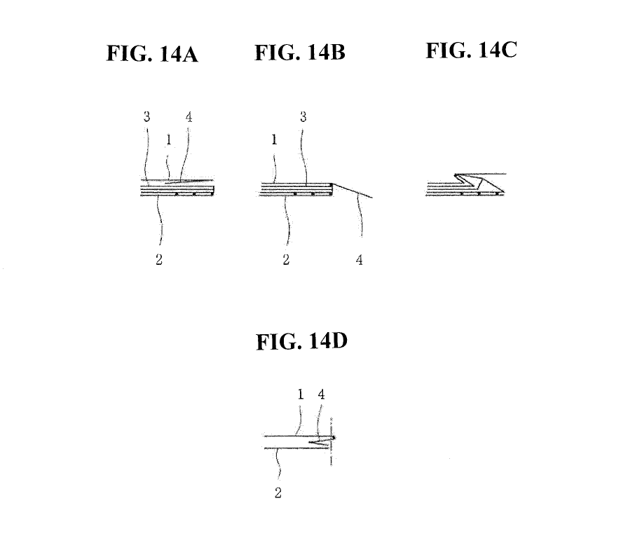

In order to make one of the webs of panel material folded in the apparatus of the publication, the upper web of panel material 1 may be folded previously so that the bottom gusset portion 4 can be formed by the folded portion, as shown in FIG. 14. The bottom gusset portion 4 should then be unfolded by the guide means, the upper web of panel material 1 being folded, so that the sheet of side gusset material 3 can be pulled and opened to make an open surface formed, the open surface being covered with the bottom gusset portion 4. The upper web of panel material 1 should then be unfolded by the guide means so that the bottom gusset portion 4 can be folded and interposed between the webs of panel material 1 and 2.

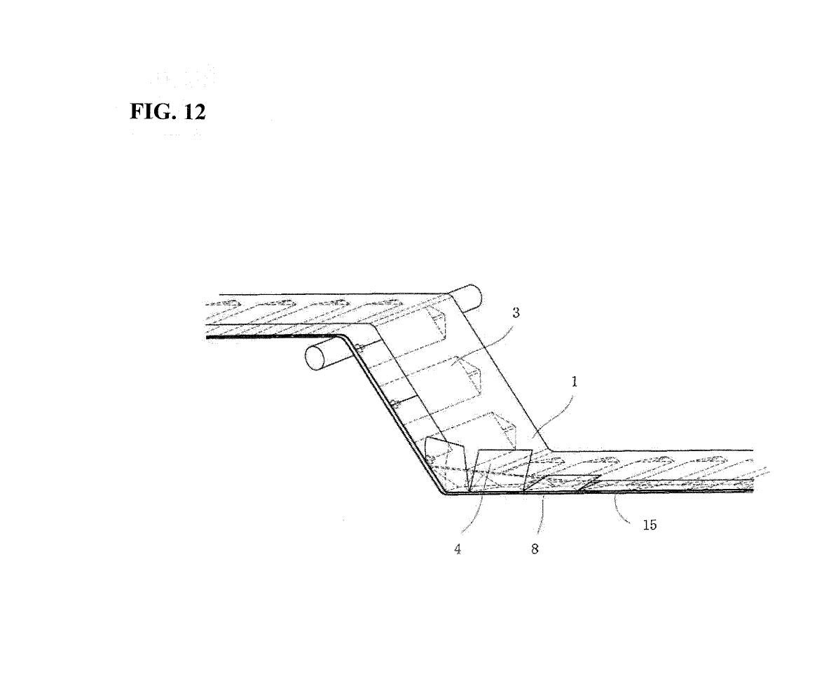

The web of bottom gusset material 4 may be slit at positions corresponding to the centerlines of the sheets of side gusset material 3 when the web of bottom gusset material 4 and the lower web of panel material 2 are temporarily fixed to each other, as shown in FIG. 12. In this case, the web of bottom gusset material 4 is easy to pushed upwardly by the upper web of panel material 1 raised and folded by the guide means. Perforations or micro joints may be formed in the web of bottom gusset material 3 at positions corresponding to the centerlines of the sheets of side gusset material 3 so that the web of bottom gusset material 4 can be torn at the perforations or micro joints when being pushed upwardly by the upper web of panel material 1.

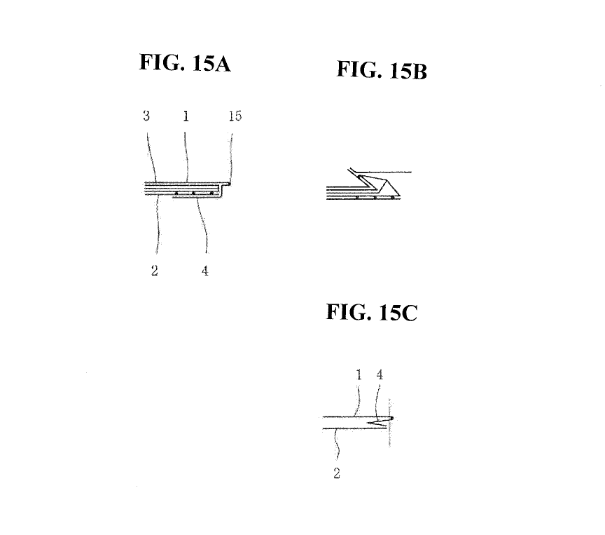

The web of bottom gusset material 4 may be supplied to the lower web of panel material 2 to be superposed on the lower surface thereof, as shown in FIG. 15. The web of bottom gusset material 4 and the upper web of panel material 1 should then be temporarily fixed at one of the opposite side edges thereof. In addition, the upper web of panel material 1 is guided by the guide means to be folded and then unfolded after being temporarily fixed.

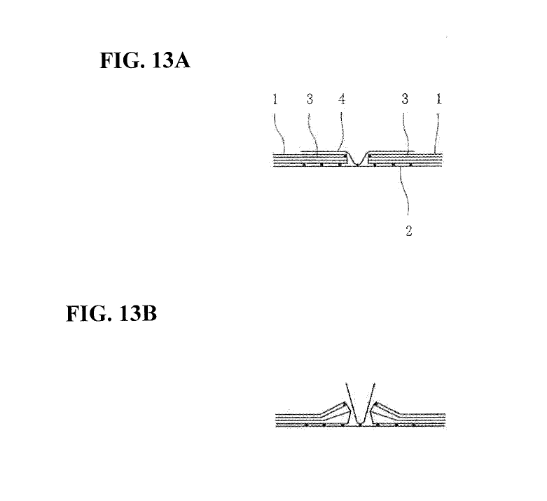

In order to successively make the plastic bags two by two in the way of FIG. 1, the apparatus should includes dividing means by which one of the webs of panel material 1 is divided widthwise thereof to have a pair of divided side edges extending longitudinally of the webs of panel material, as shown in FIG. 13. The apparatus should further include bottom gusset material supply means by which the web of bottom gusset material 4 is supplied to one of the webs of panel material 1 to be superposed on the outer surface thereof, the web of bottom gusset material 4 including a central portion disposed along the divided side edges of one of the webs of panel material 1. The apparatus should further include temporarily fixing means by which the web of bottom gusset material 4 and the other web of panel material 2 are temporarily fixed to each other at the central portion of the web of bottom gusset material 4 after the webs of panel material 1 and 2 are superposed on each other, one of the webs of panel material 1 is divided and the web of bottom gusset material 4 is supplied. The apparatus should further include guide means by which one of the webs of panel material 1 and the web of bottom gusset material 4 are guided so that one of the webs of panel material 1 can be folded at a position adjacent to the divided side edges thereof when the webs of panel material 1 and 2 are fed. The web of bottom gusset material 4 is combined with the webs of panel material 1 and 2.

The apparatus may further include side gusset material supply means by which the sheets of side gusset material 3 are supplied to and interposed between the webs of panel material 1 and 2 to extend widthwise thereof before the web of bottom gusset material is combined. The sheets of side gusset material 3 are disposed on opposite sides of the divided edges widthwise of the webs of panel material 1 and 2.

In addition, one of the webs of panel material 1 is guided by the guide means to be unfolded after being fed, the web of bottom gusset material 4 being folded and interposed between the webs of panel material 1 and 2. The web of bottom gusset material 4 is combined with the sheet of side gusset material by procedures in which one of the webs of panel material 1 folded and then unfolded.

The apparatus should further include longitudinal seal means by which the webs of panel material 1 and 2 and the web of bottom gusset material 4 are heat sealed with each other along the divided side edges of one of the webs of panel material 1 after the web of bottom gusset material 4 is combined. The apparatus should further include cross seal means by which the webs of panel material 1 and 2 and the sheet of side gusset material 3 are heat sealed with each other widthwise of the webs of panel material 1 and 2 after the web of bottom gusset material 4 is combined. The webs of panel material 1 and 2 and the web of bottom gusset material 4 are then slit at the center portion of the web of bottom gusset material 4 widthwise thereof, to successively make the plastic bags two by two. The plastic bag includes the panel portions 1 and 2 formed by the webs of panel material, the bottom gusset portion 4 formed by the web of bottom gusset material and the side gusset portions 3 formed by the sheets of side gusset material.

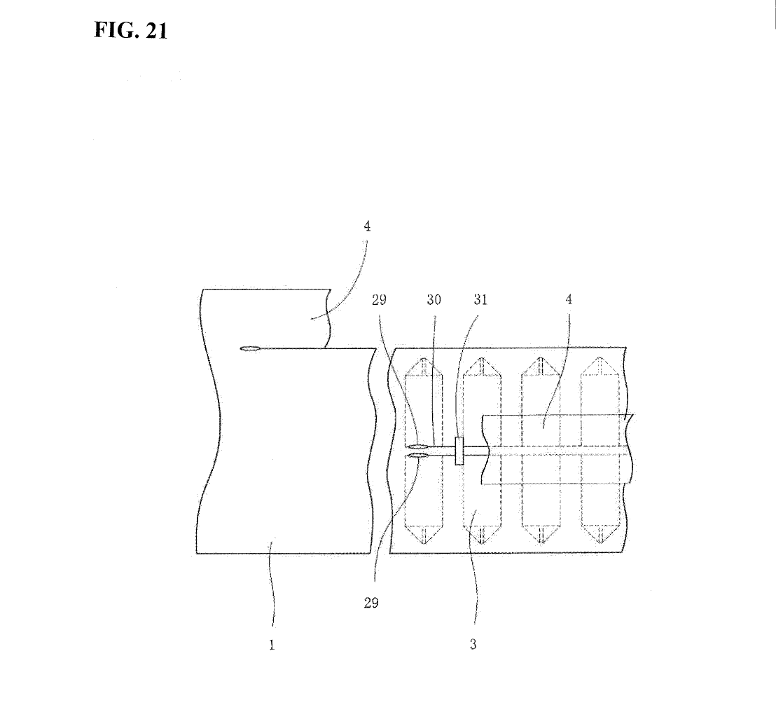

In the embodiment of FIG. 13, the dividing means may comprise a pair of slitting blades 29 spaced from each other widthwise of the webs of panel material 1 and 2, as shown in FIG. 21. One of the webs of panel material 1 is slit to be divided along longitudinal slit lines 30 by the slitting blades 29 so that the divided side edges can be spaced from and opposed to each other widthwise of the webs of panel material 1 and 2.

In addition, an elongated portion is formed between the divided side edges and then separated from one of the webs of panel material 1. The elongated portion may be directed to a guide roller 31 and a take up roll to be taken up about the take up roll and separated from one of the webs of panel material 1. The web of bottom gusset material 4 and the other web of panel material 2 can therefore be temporarily fixed to each other directly.

The dividing means may comprise a pair of perforating blades spaced form each other widthwise of the webs of panel material 1 and 2. One of the webs of panel material 1 is perforated to be divided along longitudinal perforations by the perforating blades so that the divided side edges can be spaced from and opposed to each other widthwise of the webs of panel material 1 and 2.

In addition, the elongated portion is directed to the guide roller 31 and the take up roll to be taken up about the take up roll and torn and separated from one of the webs of panel material 1. The web of bottom gusset material 4 and the other web of panel material 2 can therefore be temporarily fixed to each other directly.

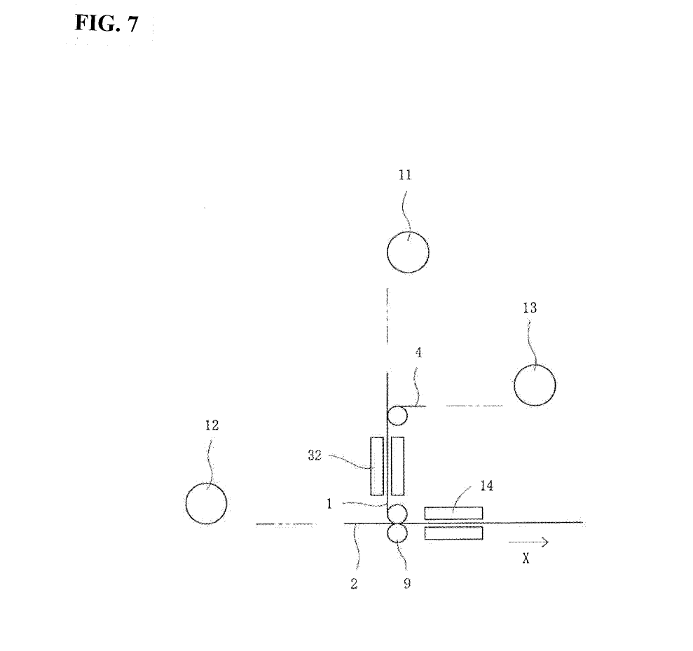

In the embodiments, the web of bottom gusset material 4 may be supplied to one of the webs of panel material 1 before the upper and lower webs 1 and 2 are superposed on each other, as shown in FIG. 7. The web of bottom gusset material 4 and the other web of panel material 2 are then temporarily fixed to each other by the ultrasonic seal means 14 after the webs of panel material 1 and 2 are superposed.

In the embodiment of FIG. 13, the apparatus may further comprise temporarily fixing means such as a ultrasonic seal means 32 by which the web of bottom gusset material 4 and one of the webs of panel material 1 are temporarily fixed to each other at the central portion of the web of bottom gusset material 4 after the web of bottom gusset material 4 is supplied. An elongated portion is formed between the divided edges and then separated from one of the webs of panel material 1 so that the web of bottom gusset material 4 and the other web of panel material 2 can be temporarily fixed to each other indirectly by the elongated portion which is temporarily fixed to the other web of panel material 2 directly.

In this case, the web of bottom gusset material 4 and one of the webs of panel material 1 are fed integrally with each other after being temporarily fixed, keeping the relationship in position between the web of bottom gusset material 4 and one of the webs of panel material 1.

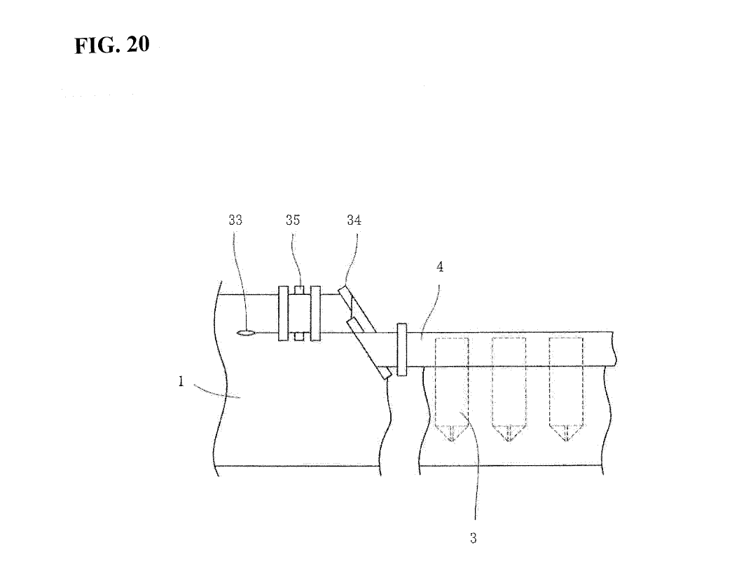

In the embodiments, the apparatus may include a slitting blade 33 by which a plastic film is slit along a longitudinal slit line to be divided into one of the webs of panel material 1 and a web of bottom gusset material 4 after supplied from a roll, as shown in FIG. 20. The apparatus should further include guide means such as a guide roller 34 by which the web of bottom gusset material 4 is guided to be changed in direction and supplied to one of the webs or the other web of panel material. In this case, there is no discrepancy in pattern between one of the webs of panel material 1 and the web of bottom gusset material 4 when a pattern is printed on one of the webs of panel material 1 and the web of bottom gusset material 4. A dancer roller 35 may be engaged with the web of bottom gusset material 4 to give the web of bottom gusset material 4 a tension.

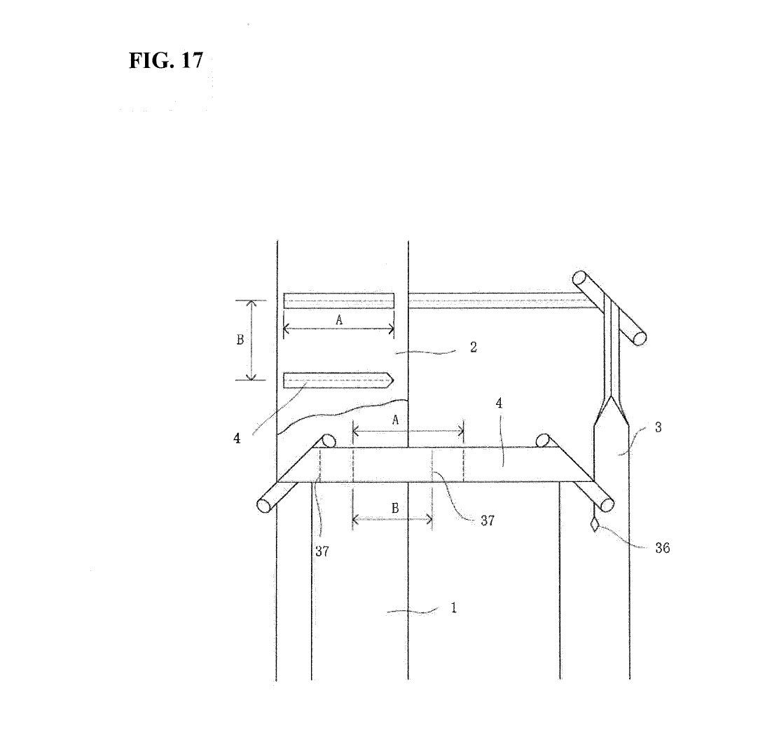

The apparatus may include a slitting blade 36 by which a plastic film is slit along a longitudinal slit line to be divided into a web of side gusset material 3 and a web of bottom gusset material 4 after being supplied from a roll, as shown in FIG. 17. The apparatus should further include guide means by which the web of side gusset material 3 is guided to be folded into halves on the opposite sides of the centerline thereof and then supplied to and interposed between the webs of panel material 1 and 2 in the form of sheets of side gusset material. The sheet of side gusset material has a length A. The apparatus should further include guide means by which the web of bottom gusset material 4 is guided to be supplied to and superposed on one of the webs or the other web of panel material. In addition, a perforating blade may be pressed against the web of bottom gusset material 4 so that perforations 37 can be formed in the web of bottom gusset material 4. The web of bottom gusset material 4 is then held by a clamp or vacuum pad and torn at the perforations 37 to have a length B shorter than the length A of the sheet of side gusset material.

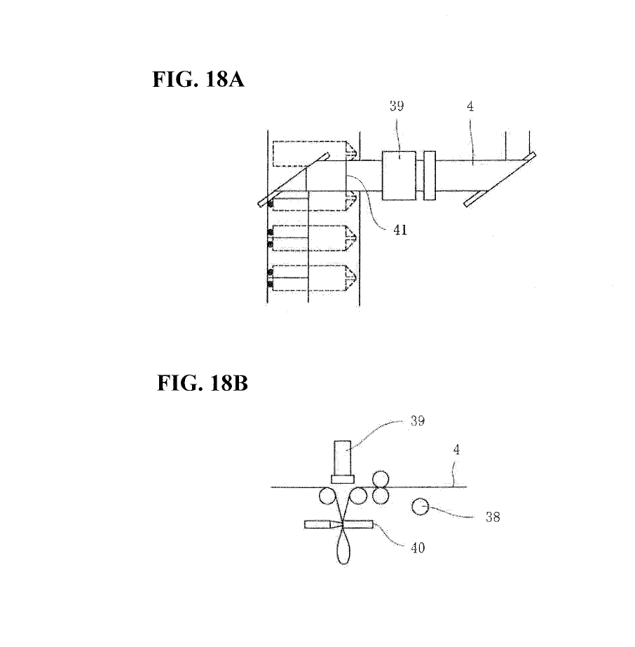

Marks may be placed on the web of bottom gusset material 4 and detected by a mark sensor 38 which generates a signal, as shown in FIG. 18. The web of bottom gusset material 4 is pressed and moved downwardly by air directed from an air nozzle 39 in response to the signal. The web of bottom gusset material 4 is then heat cut by a heater 40 to make a heat cut line 41 formed so that the web of bottom gusset material 4 can have the length B shorter than the length A of the sheet of side gusset material.

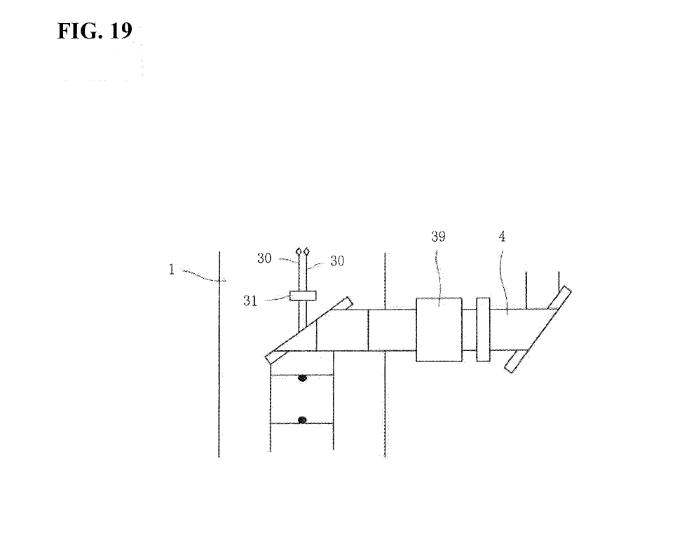

In the embodiment of FIG. 13, air may be directed from the air nozzle 39, as shown in FIG. 19. The web of bottom gusset material 4 is then heat cut by the heater 40.

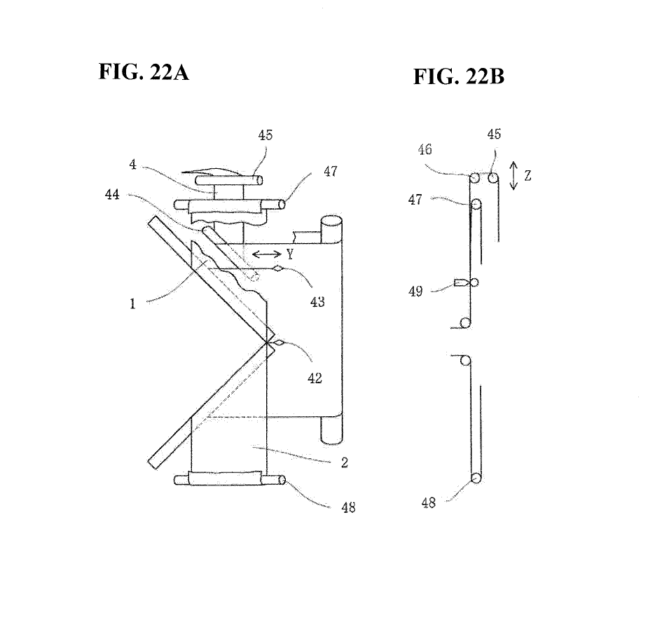

It is known that a plastic film is supplied from a roll, accumulated in an accumulator and then slit by a slitting blade 42 to be divided into the webs of panel material 1 and 2, as shown in FIG. 22. In addition, the plastic film may be slit by a slitting blade 43 to be divided into the web of panel material 1 and the web of bottom gusset material 4. The web of bottom gusset material 4 may be directed to a turn bar 44 to be changed in direction. The turn bar 44 is moved in a direction Y in which the plastic film is supplied so that the web of bottom gusset material 4 can be moved by the turn bar 44 for adjustment in position. The web of bottom gusset material 4 is disposed in position widthwise of the web of panel material 1. In addition, the web of bottom gusset material 4 is directed to guide rollers 45 and 46 to be changed in direction. The web of panel material 1 is directed to a guide roller 47 to be changed in direction. The web of panel material 2 is directed to a guide roller 48 to be changed in direction. Furthermore, the guide roller 45 is moved in a direction Z in which the web of bottom gusset material 4 is supplied so that the web of bottom gusset material 4 can be moved by the guide roller 45 to find no discrepancy in pattern between the web of panel material 1 and the web of bottom gusset material 4 when the pattern is printed. The web of bottom gusset material 4 and the web of panel material 1 may be temporarily fixed to each other by a ultrasonic seal means 49 or hot melt.

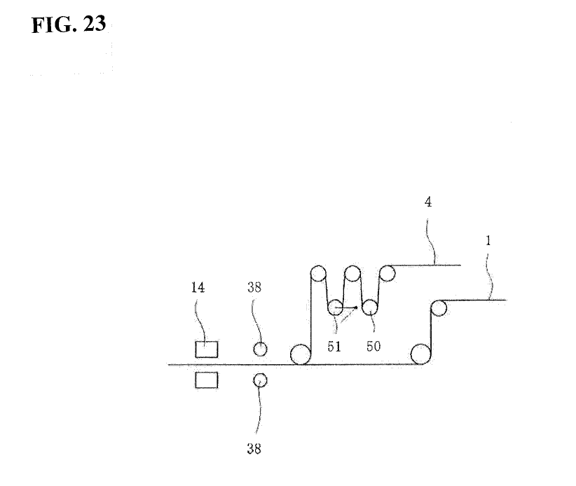

In an embodiment of FIG. 23, the web of bottom gusset material 4 is fed continuously, directed to dancer rollers 50 and 51 and superposed on the web of panel material 1 after the plastic film is divided. The web of bottom gusset material 4 and the web of panel material 1 are then temporarily fixed to each other by the ultrasonic seal means 14. The web of panel material 1 is fed intermittently while the web of bottom gusset material 4 is accumulated by and supplied from the dancer rollers 50 and 51. In addition, drive means is connected to the dancer roller 51 so that the dancer roller 51 can be pushed and moved downwardly to give the web of bottom gusset material 4 a tension. Furthermore, marks are placed on the web of panel material 1 and the web of bottom gusset material 4 and detected by mark sensors 38 which generates signals. The drive means is controlled by a control device in response to the signal of the mark sensors 38 for adjustment of the tension. There is therefore no discrepancy in pattern between the web of bottom gusset material 4 and the web of panel material 1 when the pattern is printed. A brake may be applied on the dancer roller 51 to generate a friction between the web of bottom gusset material 4 and the dancer roller 51. The brake is adjusted by the control device in response to the signal of the mark sensors 38 to find no discrepancy in pattern between the web of bottom gusset material 4 and the web of panel material 1.

1-21: (canceled)

22: An apparatus for successively making plastic bags each of which includes panel portions and a bottom gusset portion, the apparatus comprising:
panel material feeding means by which upper and lower webs of panel material are superposed on each other and fed longitudinally thereof, the webs of panel material having outer surfaces;
dividing means by which one of the webs of panel material is divided widthwise thereof to have a pair of divided side edges extending longitudinally of the webs of panel material;
bottom gusset material supply means by which a web of bottom gusset material is supplied to one of the webs of panel material to be superposed on the outer surface thereof, the web of bottom gusset material including a central portion disposed along the divided side edges of one of the webs of panel material;
temporarily fixing means by which the web of bottom gusset material and the other web of panel material are temporarily fixed to each other at the central portion of the web of bottom gusset material and between the divided side edges of one of the webs of panel material after the webs of panel material are superposed on each other, one of the webs of panel material is divided and the web of bottom gusset material is supplied; and
guide means by which one of the webs of panel material and the web of bottom gusset material are guided so that one of the webs of panel material can be folded at a position adjacent to the divided side edges thereof when the webs of panel material are fed and after the web of bottom gusset material and the other web of panel material are temporarily fixed, the web of bottom gusset material being combined with the webs of panel material, the panel portions being formed by the webs of panel material, the bottom gusset portion being formed by the web of bottom gusset material.

23: The apparatus as set forth in claim 22 further comprising:
side gusset material supply means by which sheets of side gusset material are supplied to and interposed between the webs of panel material to extend widthwise thereof before the web of bottom gusset material is combined, the sheets of side gusset material being disposed on opposite sides of the divided side edges widthwise of the webs of panel material, one of the webs of panel material being guided by the guide means to be folded after the sheet of side gusset material is interposed, the web of bottom gusset material being combined with the sheet of side gusset material, the plastic bag including side gusset portions formed by the sheets of side gusset material.

24: The apparatus as set forth in claim 23 further comprising:
longitudinal seal means by which the webs of panel material and the web of bottom gusset material are heat sealed with each other along the divided side edges of one of the webs of panel material after the web of bottom gusset material is combined; and
cross seal means by which the webs of panel material and the sheet of side gusset material are heat sealed with each other widthwise of the webs of panel material after the web of bottom gusset material is combined.

25: The apparatus as set forth in claim 23 wherein one of the webs of panel material is guided by the guide means to be unfolded after being folded, the web of bottom gusset material being folded and interposed between the webs of panel material, the web of bottom gusset material being combined with the sheet of side gusset material by means of procedures in which one of the webs of panel material is folded and then unfolded.

26: The apparatus as set forth in claim 22 wherein the dividing means comprises a pair of slitting blades spaced from each other widthwise of the webs of panel material, one of the webs of panel material being slit to be divided along longitudinal slit lines by the slitting blades so that the divided side edges can be spaced from and opposed to each other widthwise of the webs of panel material.

27: The apparatus as set forth in claim 22 wherein the dividing means comprises a pair of perforating blades spaced from each other widthwise of the webs of panel material, one of the webs of panel material being perforated to be divided along longitudinal perforations by the perforating blades so that the divided side edges can be spaced from and opposed to each other widthwise of the webs of panel material.

28: The apparatus as set forth in claim 22 wherein an elongated portion is formed between the divided side edges and then separated from one of the webs of panel material so that the web of bottom gusset material and the other web of panel material can be temporarily fixed to each other directly.

29: The apparatus as set forth in claim 22 further comprising:
temporarily fixing means by which the web of bottom gusset material and one of the webs of panel material are temporarily fixed to each other at the central portion of the web of bottom gusset material after the web of bottom gusset material is supplied, an elongated portion being formed between the divided side edges and then separated from one of the webs of panel material so that the web of bottom gusset material and the other web of panel material can be temporarily fixed to each other indirectly by the elongated portion which is temporarily fixed to the other web of panel material directly.

30: The apparatus as set forth in claim 22 wherein the web of bottom gusset material is supplied to one of the webs of panel material after the webs of panel material are superposed on each other.

31: The apparatus as set forth in claim 22 wherein the web of bottom gusset material is supplied to one of the webs of panel material before the webs of panel material are superposed on each other.
